(19) United States
(12) Patent Application Publication
(10) Pub. No.: US 2021/0111438 A1
(43) Pub. Date: Apr. 15, 2021

(54) BATTERY UNIT FOR A VEHICLE WITH A SEPARATE COMMUNICATION UNIT

(71) Applicant: ROBERT BOSCH GMBH, Stuttgart (DE)

(72) Inventors: Manuel Hohenauer, Beilstein (DE); Andreas Lemke, Berlin (DE); Bernd Heppner, Schwieberdingen (DE); Frank Stiegler, Affalterbach (DE); Henryk Weihs, Abstatt (DE); Jens Koerner, Bretzfeld-Scheppach (DE); Karl Kloess, Vaihingen (DE); Klaus-Juergen Schuler, Leingarten (DE); Matthias Gernsbeck, Karlsruhe-Gruenwettersbach (DE); Michael Steil, Korntal-Muenchingen (DE); Steffen Adolf, Asperg (DE)

(21) Appl. No.: 16/463,414

(22) PCT Filed: Nov. 8, 2017
(86) PCT No.: PCT/EP2017/078519

§ 371 Date: May 23, 2019

(30) Foreign Application Priority Data
Nov. 23, 2016 (DE) 10 2016 223 154.5

(51) Int. Cl. H01M 10/42; H02J 7/00

(52) U.S. Cl. CPC H01M 10/425; H02J 7/00036; H01M 2010/4278; H01M 2010/4271; H01M 2220/20

(57) ABSTRACT

The invention relates to a battery unit (10) for use on an on-board power system (50) of a motor vehicle, comprising a battery module (20) and a battery management system (40) for monitoring and regulating the battery module (20). In this context, a communication unit (30) is detachably connected to the battery management system (40), which communication unit (30) has a receiver unit for receiving data from the battery management system (40), a conversion unit for converting the data received by the battery management system (40), and a transmission unit for transmitting converted data to a control device of the motor vehicle.

### BACKGROUND OF THE INVENTION

The invention relates to a battery unit for use in an electrical system of a motor vehicle, in particular a motor vehicle with an internal combustion engine, comprising a battery module and a battery management system for monitoring and controlling the battery module.

Lead acid batteries are generally used as an energy store in a 12-V electrical system in conventional motor vehicles with an internal combustion engine. Such a lead acid battery, which has a positive pole and a negative pole, is used, inter alia, as a starter battery for starting the internal combustion engine. The electrical system and its functionalities are matched to the properties of the lead acid battery, for example internal resistance, charging/discharging characteristic curve and no-load voltage.

The important factor in this case is to correctly detect the state of the lead acid battery in the motor vehicle. The state, in particular the state of charge, of the lead acid battery is used by the motor vehicle as a basis for energy management functions and can therefore have a greatly negative effect on the vehicle behavior and the availability in the case of incorrect detection. Safety-relevant functionalities of the motor vehicle can also be affected thereby.

A battery sensor which is connected to the negative pole and to the positive pole of the lead acid battery typically detects the state of the lead acid battery. In this case, the battery sensor measures, inter alia, a current flowing through the lead acid battery and a voltage applied to the poles of the lead acid battery. The battery sensor determines, in particular, the state of charge and the ageing of the lead acid battery from the measured values. The battery sensor transmits the relevant determined values to a corresponding control device of the motor vehicle via a bus system.

If a lead acid battery fails, it may be advantageous to replace it with a lithium ion battery. However, on account of the different technology, a lithium ion battery has different properties to a lead acid battery. These include, inter alia, a lower internal resistance and, in particular, a different relationship between the state of charge and the output voltage. For example, a state of charge of the lithium ion battery, as determined by the battery sensor present in the motor vehicle, would therefore be incorrect.

The battery sensor present in the motor vehicle would therefore transmit incorrect data to the control device of the motor vehicle. Accordingly, in the event of a replacement, a lithium ion battery would have to replace not only the conventional lead acid battery but also the battery sensor and its functionality.

CN 104518247 A discloses a battery sensor which can calculate the state of charge of a replaced battery with an unknown capacity. In this case, the battery sensor comprises a measuring unit for measuring current and voltage, in particular a no-load voltage of the replaced battery.

US 2015/0207355 A1 discloses a system for using a plurality of batteries. For this purpose, the system comprises a monitoring unit which categorizes the batteries according to the state of health and/or internal resistance and causes batteries with a similar state of health and/or internal resistance to be uniformly discharged. In this case, the monitoring unit is connected to the batteries by means of a data connection.

### SUMMARY OF THE INVENTION

A battery unit for use in an electrical system of a motor vehicle is proposed. The battery unit comprises a battery module and a battery management system for monitoring and controlling the battery module. The battery unit is used, in particular, to replace a failed lead acid battery as a starter battery for an internal combustion engine of the motor vehicle and to replace an associated battery sensor.

According to the invention, the battery unit also comprises a communication unit which is releasably connected, preferably by means of a plug connector, to the battery management system. In this case, the communication unit has a receiving unit for receiving data from the battery management system, a conversion unit for converting the data received from the battery management system, and a transmission unit for transmitting converted data to a control device of the motor vehicle.

In this case, the communication unit partially undertakes the function of the previous battery sensor. In particular, the communication unit transmits data relating to the battery module, such as in particular a state of charge of the battery module, to the control device of the motor vehicle. However, in contrast to the previous battery sensor, the communication unit does not require a voltmeter and an ammeter. Corresponding data relating to the battery module are transmitted from the battery management system to the communication unit.

The receiving unit receives data from the battery management system. The conversion unit converts the data received from the battery management system into a form which can be read by the control device of the motor vehicle. The transmission unit then transmits the converted data to the control device of the motor vehicle.

The battery module of the battery unit preferably has a plurality of battery cells in the form of lithium ion cells. In comparison with cells of lead acid batteries, lithium ion cells have, in particular, an extended service life, an improved cycle stability, a higher energy density and also a higher power density.

In this case, the type of battery cells is not limited to lithium ion cells. In principle, all types of secondary cells which have improved properties in comparison with the lead acid battery cells are suitable. For example, lithium sulfur cells, lithium air cells, supercapacitors (supercaps, SC), lithium capacitors and battery cells with solid electrolytes are suitable.

The communication unit is preferably arranged outside a housing in which the battery module is arranged. As a result, the communication unit is accessible from the outside and can be replaced relatively easily.

The communication unit is preferably also arranged outside a housing in which the battery management system is arranged. In this case, the battery module and the battery management system can be arranged in the same housing. However, it is also conceivable for the battery management system to be arranged in its own housing separate from the battery module with the battery cells.

According to one advantageous configuration of the invention, the communication unit can be releasably connected to a communication line of the motor vehicle. The communication line of the motor vehicle is used to transmit data to the control device of the motor vehicle. The communication line comprises, for example, a plug connector for connection to a corresponding mating plug connector of the previous battery sensor. The communication unit has an identical mating plug connector, for example. The plug connector of the communication line can therefore be releasably connected to the mating plug connector of the communication unit.

According to one preferred configuration of the invention, the transmission unit of the communication unit converts the data converted by the conversion unit into a standardized bus protocol. In this case, the bus protocol is respectively specific to the bus system of the relevant motor vehicle in which the battery unit according to the invention is installed. For example, it may be a CAN bus or a LIN bus.

According to one advantageous development of the invention, the communication unit is held on a holder on a housing in a form-fitting and/or force-fitting manner, in which housing the battery module and/or the battery management system is/are arranged.

According to one preferred development of the invention, the communication unit also has a configuration unit for configuring and/or programming the receiving unit, the conversion unit and/or the transmission unit. In particular, the conversion unit and the transmission unit can be adapted to the control device and to the bus system of the relevant motor vehicle by means of the configuration unit.

The communication unit advantageously has at least one programmable microprocessor. In this case, the programmable microprocessor is integrated in the configuration unit, in particular.

A battery unit according to the invention is advantageously used in an electrical system of a motor vehicle, in particular a motor vehicle with an internal combustion engine, and, in particular, to replace a conventional lead acid battery. However, other uses, for example in electrical systems of other motor vehicles, for example hybrid vehicles, plug-in hybrid vehicles and electric vehicles, are also conceivable.

The invention makes it possible to replace a conventional 12-V lead acid battery with a 12-V lithium ion battery having a battery management system while ensuring all functionalities, in particular the energy management, in the motor vehicle. A battery sensor having a voltmeter and an ammeter which was previously present in the motor vehicle and is matched to the properties of the replaced lead acid battery is no longer required. The communication unit therefore makes it possible to use a lithium ion battery in motor vehicles which are matched to the properties of a lead acid battery.

Identical battery modules, in particular battery modules with lithium ion cells, can be used in different motor vehicles. Only one type of battery module with a battery management system therefore needs to be produced and stocked. This reduces costs of storage, in particular. The adaptation to the respective motor vehicle is carried out by selecting the communication unit suitable for the motor vehicle. Only different communication units therefore need to be produced and stored. However, in comparison with a battery module, a communication unit is relatively small and space-saving and has a considerably lower weight.

If the communication unit is programmable, the adaptation to the respective motor vehicle can be carried out by means of appropriate programming. This further increases the flexibility of the battery unit according to the invention. In this case, only one type of communication unit also needs to be produced and stocked, thus reducing the costs of storage yet further.

### BRIEF DESCRIPTION OF THE DRAWINGS

Embodiments of the invention are explained in more detail on the basis of the drawings and the following description.

In the drawings:

FIG. 1 shows a battery unit in an electrical system of a motor vehicle, and

FIG. 2 shows a communication unit of the battery unit from FIG. 1.

### DETAILED DESCRIPTION

In the subsequent description of the embodiments of the invention, identical or similar elements are denoted using identical reference signs, in which case a repeated description of these elements is dispensed with in individual cases. The figures only schematically illustrate the subject matter of the invention.

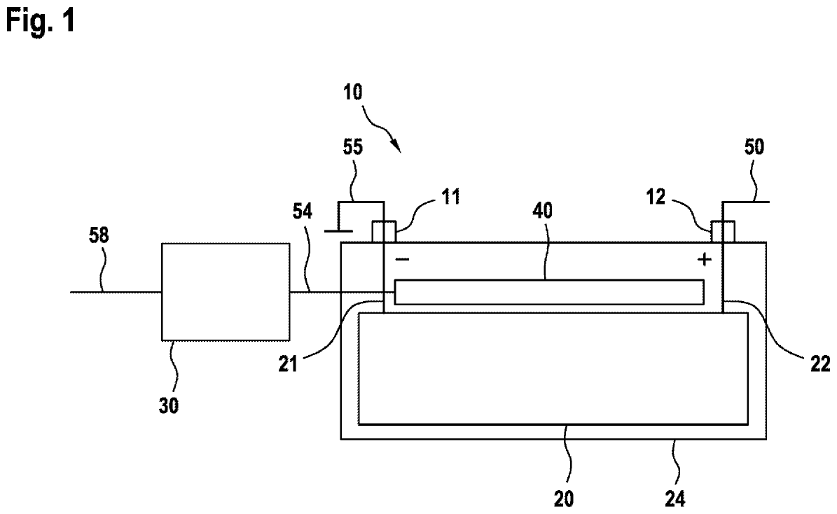

FIG. 1 shows a battery unit 10 in an electrical system 50 of a motor vehicle. In this context, the live supply lines in the motor vehicle are referred to as the electrical system 50. In the present case, the electrical system 50 has a nominal voltage of 12 volts with respect to a ground line 55 in the motor vehicle.

The battery unit 10 comprises a positive pole 12 which is connected to the electrical system 50. The battery unit 10 also comprises a negative pole 11 which is connected to the ground line 55.

The battery unit 10 comprises a battery module 20 having a plurality of battery cells which are in the form of lithium ion cells. The battery cells are connected in series, for example, and provide a nominal voltage of 12 volts. The battery module 20 has a negative terminal 21 and a positive terminal 22. The nominal voltage of 12 volts provided by said battery cells is applied between the terminals 21, 22 of the battery module 20.

The battery module 20 is arranged in a housing 24. The negative pole 11 and the positive pole 12 project from the housing 24. The negative terminal 21 is electrically connected to the negative pole 11 and the positive terminal 22 is electrically connected to the positive pole 12. The nominal voltage of 12 volts provided by the battery cells of the battery module 20 is therefore likewise applied between the poles 11, 12.

The battery unit 10 also comprises a battery management system 40 for monitoring and controlling the battery module 20. In the present case, the battery management system 40 is likewise inside the housing 24. The battery management system 40 determines data for describing a state of the battery module 20. The battery management system 40 determines, inter alia, an instantaneous voltage, a no-load voltage, a current, a temperature, a state of charge, ageing, an internal resistance and a capacity of the battery module 20.

The battery unit 10 also comprises a communication unit 30 which, in the present case, is connected to the battery management system 40 by means of a plug connector via a data line 54. The communication unit 30 is therefore releasably connected to the battery management system 40. In this case, the communication unit 30 is arranged outside the housing 24 in which the battery module 20 and the battery management system 40 are arranged.

The battery management system 40 transmits the data for describing the state of the battery module 20 to the communication unit 30 via the data line 54. The communication unit 30 is connected to a control device (not illustrated here) of the motor vehicle by means of a communication line 58.

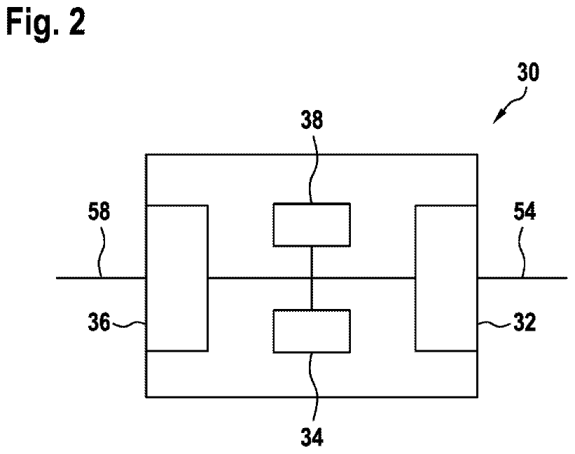

FIG. 2 shows a detailed illustration of the communication unit 30 of the battery unit 10 illustrated in FIG. 1. As already mentioned, the communication unit 30 is connected to the battery management system 40 via the data line 54. The communication unit 30 is also releasably connected to the control device of the motor vehicle by means of a plug connector via the communication line 58.

In the present case, the communication unit 30 comprises a receiving unit 32, a conversion unit 34, a transmission unit 36 and a configuration unit 38. In this case, the configuration unit 38 is used to configure and/or program the receiving unit 32, the conversion unit 34 and the transmission unit 36. The communication unit 30 also has a programmable microprocessor which is not illustrated here and, in the present case, is integrated in the configuration unit 38.

The receiving unit 32 receives the data for describing the state of the battery module 20 from the battery management system 40 via the data line 54. The conversion unit 34 converts the data which are received by the receiving unit 32 from the battery management system 40 into a form which can be read by the control device of the motor vehicle.

The transmission unit 36 then transmits the data converted in this manner to the control device of the motor vehicle via the communication line 58. In this case, the transmission unit 36 converts the data converted by the conversion unit 34 into a standardized bus protocol. The transmission unit 36 is therefore used, in particular, as a protocol converter of the communication unit 30.

The invention is not restricted to the exemplary embodiments described here and to the aspects highlighted therein. Rather, a multiplicity of modifications within the scope of the practice of a person skilled in the art are possible within the scope indicated by the claims.

1. A battery unit (10) for use in an electrical system (50) of a motor vehicle, the battery unit comprising
a battery module (20) and
a battery management system (40) for monitoring and controlling the battery module (20),
wherein
a communication unit (30) is releasably connected to the battery management system (40) and has
a receiving unit (32) for receiving data from the battery management system (40),
a conversion unit (34) for converting the data received from the battery management system (40), and
a transmission unit (36) for transmitting converted data to a control device of the motor vehicle.

2. The battery unit (10) as claimed in claim 1, wherein
the battery module (20) has a plurality of battery cells in the form of lithium ion cells.

3. The battery unit (10) as claimed in claim 1, wherein
the communication unit (30) is arranged outside a housing (24) in which the battery module (20) is arranged.

4. The battery unit (10) as claimed in claim 1, wherein
the communication unit (30) is arranged outside a housing (24) in which the battery management system (40) is arranged.

5. The battery unit (10) as claimed in claim 1, wherein
the communication unit (30) can be releasably connected to a communication line (58) of the motor vehicle.

6. The battery unit (10) as claimed in claim 1, wherein
the transmission unit (36) converts the converted data into a standardized bus protocol.

7. The battery unit (10) as claimed in claim 1, wherein
the communication unit (30) is held on a holder on a housing (24) in a form-fitting and/or force-fitting manner,
in which housing the battery module (20), the battery management system (40) or both are arranged.

8. The battery unit (10) as claimed in claim 1, wherein
the communication unit (30) has a configuration unit (38) for configuring the receiving unit (32), the conversion unit (34), the transmission unit (36), or combination of the same.

9. The battery unit (10) as claimed in claim 1, wherein
the communication unit (30) has at least one programmable microprocessor.

10. The use of a battery unit (10) as claimed in claim 1 in an electrical system (50) of a motor vehicle.
